(19) United States
(12) Patent Application Publication
(10) Pub. No.: US 2007/0290005 A1
(43) Pub. Date: Dec. 20, 2007

(54) TRIGGER SPRAYER VENTING APPARATUS

(75) Inventors: Donald D. Foster, St. Charles, MO (US); Philip L. Nelson, Wildwood, MO (US); Walter J. Clynes, O'Fallon, MO (US)

Correspondence Address: THOMPSON COBURN, LLP, ONE US BANK PLAZA, SUITE 3500, ST LOUIS, MO, 63101, US

(73) Assignee: CONTINENTALAFA DISPENSING COMPANY, St. Peters, MO (US)

(21) Appl. No.: 11/846,210

(22) Filed: Aug. 28, 2007

Related U.S. Application Data
(62) Division of application No. 11/374,916, filed on Mar. 14, 2006.

(51) Int. Cl. B05B 11/00

(52) U.S. Cl. 222/383.1

(57) ABSTRACT

A trigger sprayer has a venting apparatus with a unique construction that is formed by the combination of a sprayer housing of the trigger sprayer and a plug seal assembled to the sprayer housing. The plug seal includes a dip tube connector, a valve seat, an annular rim seal, and a portion of the air vent baffle apparatus that are combined as one integral piece.

This patent application is a divisional of application Ser. No. 11/374,916, which was filed on Mar. 14, 2006, and is currently pending.

### BACKGROUND OF THE INVENTION

(1) Field of the Invention

The present invention pertains to a trigger sprayer having a unique plug seal that is assembled between the trigger sprayer and an attached liquid container. In particular, the present invention pertains to a trigger sprayer that has a plug seal that includes a dip tube connector, a valve seat, an annular rim seal, and an air vent baffle that are all formed as one integral piece.

(2) Description of the Related Art

Trigger sprayers are those types of sprayers that can be held in a single hand of the user and operated by the fingers of the user's hand to pump liquid from a bottle connected to the trigger sprayer. A trigger sprayer typically comprises a sprayer housing that contains a pump chamber, a liquid supply passage that communicates a liquid inlet opening on the sprayer housing with the pump chamber, and a liquid discharge passage that communicates the pump chamber with a liquid outlet opening on the sprayer housing.

A dip tube is connected to the sprayer housing liquid inlet opening. The dip tube is extended through the neck of the bottle connected to the trigger sprayer, and into the liquid in the bottle. The dip tube communicates the liquid through the liquid supply passage of the sprayer housing, with the pump chamber of the sprayer housing.

A nozzle assembly is connected to the sprayer housing at the liquid outlet opening. Various different types of nozzle assemblies are known. The typical nozzle assembly is adjustable to provide various different discharge patterns of the liquid dispensed from the trigger sprayer. For example, the liquid can be dispensed in a stream or spray pattern, or as a foam.

A pump piston is mounted in the pump chamber of the sprayer housing for reciprocating movement of the piston in the pump chamber. The reciprocating movement of the piston in the pump chamber draws liquid into the pump chamber and discharges the liquid from the pump chamber and through the nozzle assembly.

A manually manipulated trigger is mounted on the sprayer housing for pivoting movement by the fingers of the user's hand. The trigger is operatively connected to the pump piston of the trigger sprayer. Manual manipulation of the trigger operates the pump, which draws liquid from the bottle connected to the trigger sprayer and dispenses the liquid from the trigger sprayer.

Many trigger sprayers are attached to their bottles by an internally threaded cap. To firmly secure the trigger sprayer on the bottle neck, the cap is positioned on the bottle neck and rotated. Complementary screw threading provided on the interior of the cap and the exterior of the bottle neck securely attach the trigger sprayer to the bottle.

Many trigger sprayers are also provided with bayonet-type connectors. Bayonet-type connectors firmly attach the trigger sprayer on the bottle neck by rotating the trigger sprayer connector cap relative to the bottle neck. Trigger sprayers with bayonet-type connectors can be attached to complementary bottle necks by rotating the trigger sprayer connector a fraction of one complete revolution relative to the bottle neck. These types of connectors are advantageously used where a trigger sprayer is attached to a bottle neck by a machine in an assembly line.

In the operation of a typical trigger sprayer, as the sprayer pump is manually operated and liquid is drawn from a liquid container attached to the trigger sprayer and dispensed by the trigger sprayer, the volume of the liquid drawn from the liquid container creates vacuum in the container. This vacuum must be relieved or the sidewalls of the liquid container will collapse. Trigger sprayers are typically constructed with a vent opening that allows the exterior environment of the trigger sprayer to communicate with the interior of the liquid container, and thereby allows the vacuum created in the liquid container to be relieved by the flow of air from the exterior environment of the trigger sprayer, through the trigger sprayer housing and into the interior of the liquid container. However, providing a flow path for air to enter the liquid container also creates the possibility of liquid leaking from the liquid container through the vent air flow path to the exterior of the sprayer housing. Thus, the typical trigger sprayer is constructed with a mechanism that opens and closes the vent air path through the sprayer housing as liquid is dispensed from the liquid container attached to the trigger sprayer.

The typical sprayer described above has several separate component parts that all contribute to the overall cost of manufacturing the trigger sprayer. Because the typical trigger sprayer is manufactured and sold in very large numbers, even the slightest reduction in the manufacturing cost of the trigger sprayer can result in significant overall reductions in the cost of manufacturing trigger sprayers. Thus, it is desirable to reduce the number of separate component parts of a trigger sprayer to reduce the manufacturing cost.

### SUMMARY OF THE INVENTION

The trigger sprayer of the invention has a unique construction that enables a reduction in the number of separate component parts of the trigger sprayer. In addition, the unique construction of the trigger sprayer of the invention provides the trigger sprayer with an improved venting apparatus that allows a free flow of venting air from the exterior environment of the trigger sprayer into the liquid container attached to the trigger sprayer, while substantially eliminating the leakage of liquid from the liquid container through the sprayer housing of the trigger sprayer.

The construction of the trigger sprayer of the invention is similar to that of conventional trigger sprayers. However, as will be explained, the unique construction features of the trigger sprayer of the invention reduce the number of component parts of the trigger sprayer.

Like a typical trigger sprayer, the trigger sprayer of the invention is comprised of a sprayer housing that contains a pump chamber. The sprayer housing also includes a circular bottom wall below the pump chamber that, in the preferred embodiment, is integrally connected to a connector cap of the trigger sprayer.

The connector cap is employed in attaching the trigger sprayer to a separate liquid container that contains a liquid to be dispensed by the trigger sprayer. The connector cap has a center axis that is coaxial with the center axis of the opening to the liquid container.

A liquid inlet opening is provided on the sprayer housing. The liquid inlet opening is positioned in the bottom wall to one side of the connector center axis. The liquid inlet opening communicates with a liquid supply passage that extends through the sprayer housing and communicates the liquid inlet opening with the pump chamber.

The sprayer housing also has a liquid outlet opening. A liquid discharge passage extends through the sprayer housing and communicates the liquid outlet opening with the pump chamber. A portion of the liquid discharge passage is coaxial with the liquid supply passage. The axially aligned portion of the liquid discharge passage and the liquid supply passage are positioned to one side of the connector cap center axis in the sprayer housing. This enables the pump chamber to extend through the sprayer housing to a greater extent where the connector cap center axis will intersect a portion of the pump chamber. This enables enlargement of the pump chamber interior volume, without increasing the width of the sprayer housing.

An air vent opening passes through the pump chamber and through the bottom wall of the sprayer housing to the interior volume of the connector cap. The vent opening communicates through the pump chamber with the exterior environment of the trigger sprayer. The vent opening is surrounded by a tube that projects from the bottom wall of the sprayer housing and into the connector cap interior volume.

It is desirable that the dip tube used with the trigger sprayer be axially aligned with the connector cap axis so that the dip tube is inserted through the center of the liquid container opening as the trigger sprayer is attached to the liquid container. In order to axially align the dip tube with the center axis of the connector cap, a novel plug seal is assembled to the sprayer housing. One of the unique features of the plug seal is that it enables the attachment of the dip tube to the trigger sprayer at a position that is axially aligned with the connector cap center axis. The plug seal also communicates the dip tube with the liquid inlet opening of the sprayer housing that is not axially aligned with the dip tube. The plug seal also has an inlet valve seat column that is assembled into the liquid supply passage of the sprayer housing. The valve seat column provides a valve seat surface for an inlet valve that controls the flow of liquid through the liquid inlet opening and the liquid supply passage to the pump chamber, and prevents the reverse flow of liquid. The plug seal is also provided with an elongate trough that forms a part of the vent air flow path. The trough extends along a surface of the plug seal in a transverse direction relative to the center axis of the connector cap. The elongate trough has opposite ends, with one end receiving the vent opening tube of the sprayer housing and the opposite end having a plug seal vent hole. When the plug seal is assembled to the sprayer housing, the trough on the plug seal and the vent opening tube on the sprayer housing combine to create a baffled vent air flow path from the exterior of the sprayer housing to the interior of the liquid container attached to the sprayer housing. The baffled air flow path allows air to easily enter the interior of the liquid container when the pump of the trigger sprayer is operated, but substantially eliminates the problem of liquid leaking from the liquid container through the vent air flow path of the trigger sprayer. Thus the plug seal of the invention combines into one component part of the trigger sprayer of the invention several desirable and necessary features for a trigger sprayer that were provided by several separate component parts of prior art trigger sprayers. In this manner the trigger sprayer of the invention provides a reduction in the component parts of the trigger sprayer that provides for reduced manufacturing cost, and also provides for a trigger sprayer venting apparatus that is easily assembled in the trigger sprayer and allows for vent air to enter the liquid container attached to the trigger sprayer while substantially limiting the problem of liquid leaking from the liquid container through the vent air flow path.

### BRIEF DESCRIPTION OF THE DRAWINGS

Further features of the present invention are set forth in the detailed description of the preferred embodiment of the invention and in the drawing figures wherein:

FIG. 1 is a side elevation view, in section, of a trigger sprayer employing the connector apparatus of the present invention;

FIG. 2 is a top perspective view of a bottle neck that employs the connector apparatus of the invention;

FIG. 3 is a bottom perspective view of the trigger sprayer connector of the invention;

FIG. 4 is a top plan view of the bottle neck of FIG. 2;

FIG. 5 is a bottom plan view of the trigger sprayer connector of FIG. 3;

FIG. 6 is a side elevation view, in section, of a trigger sprayer similar to that of FIG. 1 that includes a plug seal construction similar to that of FIG. 1;

FIG. 7 is a partial, enlarged, cross-section view of the trigger sprayer housing of FIG. 6 with the plug seal removed;

FIG. 8 is a partial, enlarged, cross-section view of the portion of the trigger sprayer housing shown in FIG. 7 in the plane of the line 8-8 of FIG. 7;

FIG. 9 is a bottom plan view of the sprayer housing of FIG. 6 with the plug seal removed;

FIG. 10 is a top perspective view of the plug seal removed from the sprayer housing;

FIG. 11 is a top plan view of the plug seal; and

FIG. 12 is a side, cross-section view of the plug seal in the plane of the line 12-12 of FIG. 11.

### DETAILED DESCRIPTION OF THE PREFERRED EMBODIMENT

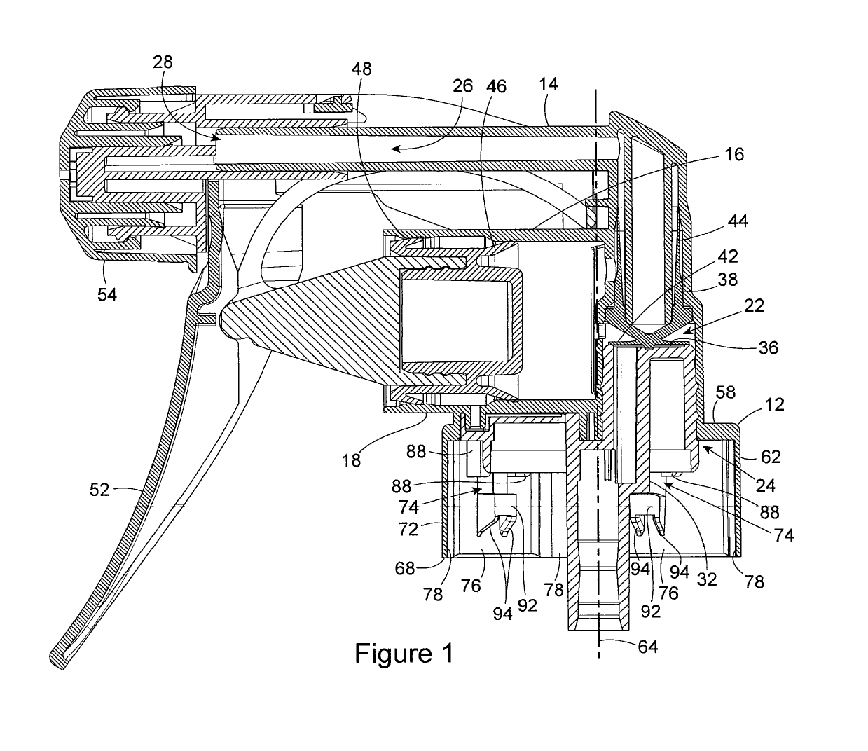

FIG. 1 shows an example of a trigger sprayer construction employing the connector apparatus of the present invention. It should be understood that the trigger sprayer construction shown in FIG. 1 is only one example of a trigger sprayer that can employ the connector apparatus of the present invention. There are various other different designs of trigger sprayers that are equally well suited for use with the connector apparatus of the invention. Furthermore, the connector apparatus of the invention is shown in FIG. 1 as one, integral piece with the sprayer housing of the trigger sprayer. In the preferred embodiment of the invention, the connector apparatus is connected as a single piece with the sprayer housing. However, in alternate embodiments of the invention, the connector apparatus could be a separate piece from the trigger sprayer housing that is assembled to the trigger sprayer housing. Because the trigger sprayer shown in FIG. 1 is only one example of a trigger sprayer construction that can employ the connector apparatus of the invention, the trigger sprayer will be described only generally herein.

In the preferred embodiment of the connector apparatus shown, the connector apparatus includes a connector cap 12 that is formed in one piece with the sprayer housing 14 of the trigger sprayer. The sprayer housing 14 contains a cylindrical pump chamber 16, a cylindrical vent chamber 18, a liquid supply passage 22 that extends from a liquid inlet opening 24 in the sprayer housing to the pump chamber 16, and a liquid discharge passage 26 that extends from the pump chamber 16 to a liquid outlet opening 28 in the sprayer housing.

A plug seal 32 having an integral dip tube connector, a bottle neck rim seal, a baffled air vent, and an input valve seal is inserted into the liquid inlet opening 24 of the sprayer housing. The dip tube connector of the plug seal 32 connects a dip tube (not shown) with the sprayer housing 14. The input valve seat at the top of the plug seal 32 has a surface 36 that functions as an input valve seat in the liquid supply passage 22.

A two piece valve assembly 38 is inserted into the sprayer housing 14 above the dip tube connector 32. The valve assembly 38 has a flexible disk valve 42 at its lower end that seats against the valve seat surface 36 of the dip tube connector 32. The disk valve 42 controls the flow of liquid through the dip tube 34 and the dip tube connector 32 to the pump chamber 16, and prevents the reverse flow of liquid. A flexible sleeve valve 44 projects upwardly from the valve assembly 38. The sleeve valve 44 controls the flow of liquid from the pump chamber 16 through the liquid discharge passage 26 to the liquid outlet opening 28, and prevents the reverse flow of liquid.

A pump piston 46 is mounted in the pump chamber 16 for reciprocating movements between charge and discharge positions of the pump piston in the pump chamber. When moved forwardly to the charge position shown in FIG. 1, the pump piston 46 draws liquid into the pump chamber 16. When moved rearwardly to the discharge position, the pump piston 46 pumps the liquid from the pump chamber 16.

A vent piston 48 is connected to the pump piston 46 for reciprocating movements with the pump piston. The vent piston 48 is mounted in the vent chamber 18 for reciprocating movements between vent open and vent closed positions. When the pump piston 46 is moved rearwardly in the pump chamber 16 toward the discharge position, the vent piston 48 is also moved in the rearward direction in the vent chamber 18 toward the vent open position. In the vent open position, the interior of the bottle connected to the trigger sprayer is vented through the vent chamber 18 to the exterior environment of the sprayer housing 14. When the pump piston 46 is moved forwardly in the pump chamber 16 toward the charge position, the vent piston 48 is also moved forwardly in the vent chamber to the vent closed position.

A coil spring (not shown) is positioned in the pump chamber 16 and engages against the pump piston 46. The spring biases the pump piston in the forward direction toward the charge position of the piston relative to the pump chamber 16. Thus, the spring also biases the vent piston 48 in the forward direction toward the vent closed position.

A trigger 52 is mounted on the sprayer housing 14 for pivoting movement of the trigger relative to the sprayer housing. The trigger 52 is operatively connected to the pump piston 46 and the vent piston 48. Movement of the trigger 52 on the sprayer housing 14 by the user's hand holding the trigger sprayer results in the reciprocating movements of the pump piston 46 and the vent piston 48 in the respective pump chamber 16 and vent chamber 18.

An indexing nozzle 54 is mounted on the sprayer housing 14 at the liquid outlet opening 28. The nozzle 54 can be turned on the sprayer housing to selectively prevent and permit liquid discharge from the sprayer housing. In addition, the indexing nozzle 54 can be rotated to various positions of the nozzle relative to the sprayer housing 14 where the spray pattern of liquid discharged from the sprayer housing is changed between a spray, stream, and foam discharge pattern.

The construction of the trigger sprayer set forth above is typical, and is only one example of the construction of the various known types of trigger sprayers. As stated earlier, the particular construction of the trigger sprayer described herein is intended to be illustrative only, and is not intended to limit the use of the novel connector apparatus of the invention to any one particular type of trigger sprayer construction.

The connector cap 12 of the connector apparatus is formed as one monolithic piece with the sprayer housing 14. The cap 12 has a circular top wall 58 and a cylindrical sidewall 62 having a center axis 64. The center axis 64 defines mutually perpendicular axial and radial directions relative to the connector cap 12. The cap side wall 62 extends axially downwardly from the peripheral edge of the cap top wall 58 to a circular bottom edge 68 of the side wall. The cap bottom edge 68 surrounds a bottom opening to the interior volume of the cap. The cap sidewall has a smooth, cylindrical exterior surface 72 that extends completely around the cap sidewall and is only interrupted by circumferentially spaced mold holes 74.

Each of the mold holes 74 are a result of the molding process employed in forming the connector cap 12. The mold holes 74 are not essential to the functioning of the connector apparatus of the invention. The cap sidewall 62 could be formed with the lug assemblies without the mold holes 74 and the functioning of the connector cap 12 would be the same.

The cap interior surface is cylindrical and is comprised of a plurality of thick areas 76 and a plurality of thin areas 78. The thick areas 76 and thin areas 78 alternate around the circumference of the sidewall interior surface. The sidewall thick areas 76 have a first thickness dimension between the cap exterior surface 72 and the cap interior surface at the thick areas 76. The sidewall thin areas 78 have a second thickness dimension between the cap exterior surface 72 and the cap interior surface at the thin areas 78. The first thickness dimension is larger than the second thickness dimension. The cap thick areas 76 and thin areas 78 each have general rectangular configurations. The thin areas 78 extend the entire axial length of the sidewall interior surface from the cap top wall 58 to the cap bottom edge 68. Likewise, the cap thick areas 76 extend the entire axial length of the cap interior surface from the cap top wall 58 to the cap bottom edge 68. As seen in FIG. 5, the positioning of the thin areas 78 is symmetric on opposite sides of a center plane 82 that bisects the cap and the sprayer housing 14. However, the positioning of the thin areas 78 is asymmetric on opposite sides of a perpendicular plane 84 that contains the cap center axis 64 and is perpendicular to the center plane 82. Because the cap sidewall thick areas 78 have a thickness dimension that is larger than the thickness dimension of the cap sidewall thin areas 78, the cap sidewall thin areas 78 are more flexible than the cap thick areas 76.

In the preferred embodiment of the invention, the thin areas 78 of the sidewall 62 are recessed into the interior surface of the sidewall. This provides the increased flexibility in the thin areas of the sidewall while presenting the more desirable appearance of the smooth exterior surface of the sidewall. Even with the thin areas 78 recessed into the sidewall interior surface, a majority of the sidewall circumference is made up of the thick areas 76 of the sidewall. Each thin area 78 of the sidewall interior surface occupies approximately 1/24^{th} of the total circumferential dimension of the sidewall interior surface. Thus, the sidewall 62 remains substantially rigid and supports the trigger sprayer firmly on the bottle neck.

Four lug assemblies are provided on the sidewall interior surface. The lug assemblies are each comprised of a pair of circumferentially spaced upper lugs 88, and a single lower lug 92 that is axially spaced from the upper lugs. As seen in FIG. 3, the upper lugs 88 of each lug assembly are positioned on opposite sides of a mold hole 74, and the lower lug 92 of each lug assembly is positioned directly below the mold hole. Each of the lower lugs 92 has cam surfaces 94 that angle radially outwardly as they extend axially downwardly. This tapered configuration of the lower lug cam surfaces 94 facilitates the attachment of the connector cap 12 on the container neck by snap fitting the cap on the neck, as will be explained.

As seen in FIG. 5, pairs of the lug assemblies are positioned on opposite sides of the center plane 82 and on opposite sides of the perpendicular plane 84. This positions the lug assemblies to securely hold the connector cap 12 to a bottle neck.

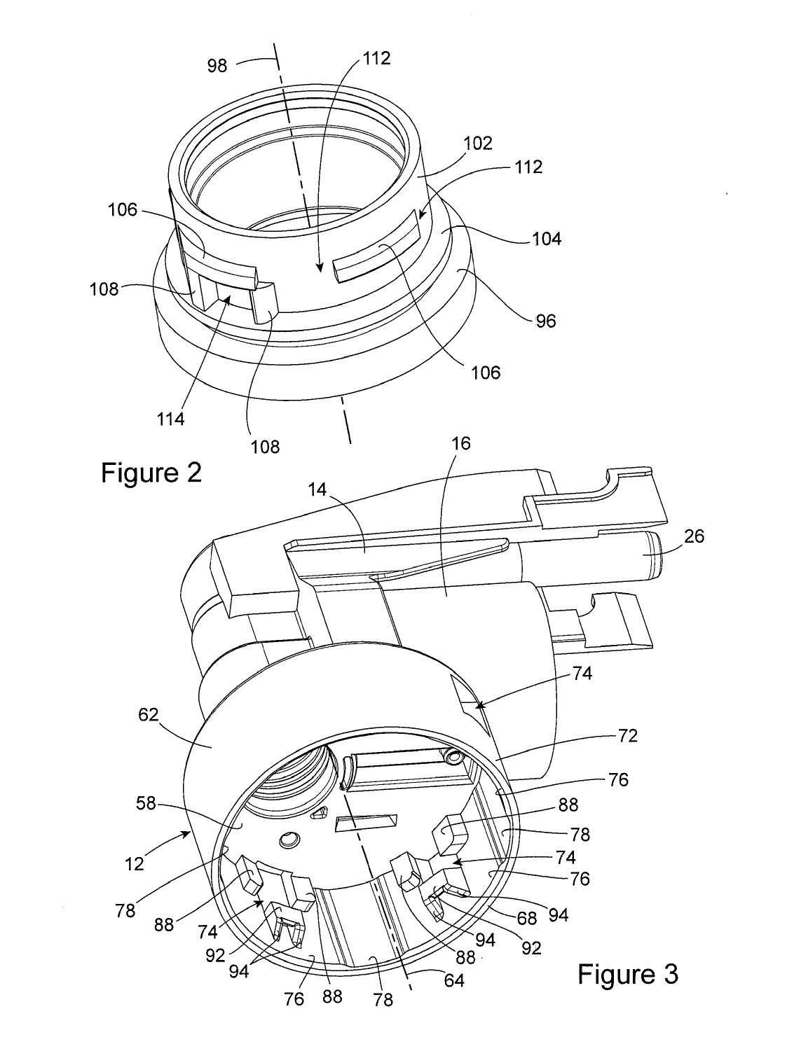

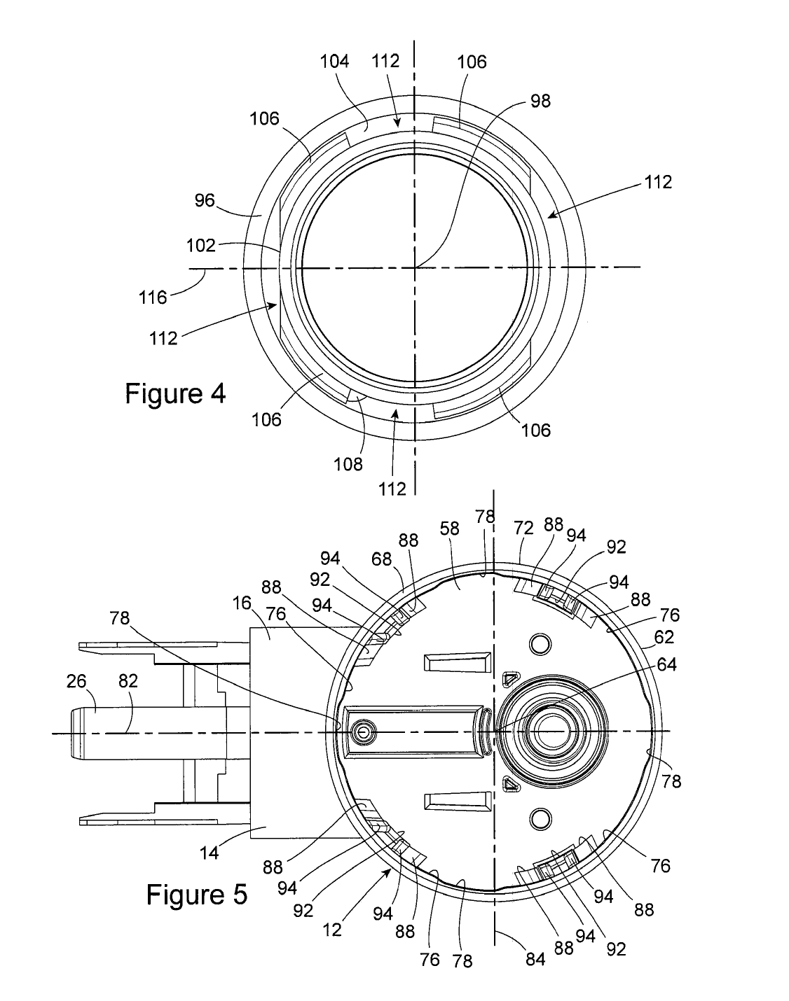

Only the top of a bottle 96 designed for use with the connector cap 12 of the invention is shown in FIGS. 2 and 4. The bottle has an opening with a center axis 98 and a cylindrical neck 102 that extends around the opening. The bottle neck opening receives the dip tube 34 of the trigger sprayer when the connector cap 12 is attached to the bottle. An annular rim 104 extends radially outwardly from the bottom of the bottle neck 102. The annular rim 104 is dimensioned to engage the interior surface of the cap sidewall 62 when the cap 12 is attached to the bottle neck 102 to stabilize the trigger sprayer on the bottle.

Just above the annular rim 104, the exterior surface 106 of the bottle neck is cylindrical and smooth except for four separate arcuate ridges 106 and two pairs of axial ridges 108. The arcuate ridges 106 are circumferentially spaced around the bottle neck. The positions of the arcuate ridges 106 correspond to the circumferential spacing of the lug assemblies on the interior surface of the cap sidewall 62. An arcuate spacing is provided between each of the arcuate ridges 106. The arcuate spacing 112 between the adjacent arcuate ridges 106 is sufficiently large to enable the lower lugs 92 of the cap lug assemblies to pass through the spacing. Each of the arcuate ridges 106 has an axial width dimension that corresponds to the axial spacing between the lower lug 92 and the upper lugs 88 of each lug assembly. In alternate embodiments of the invention, the arcuate ridges 106 could be replaced by a single circular ridge that extends entirely around the circumference of the bottle neck 102.

Each of the axial ridges 108 projects radially outwardly from the bottle neck 102 to the same extent as the arcuate ridges 106. The axial ridges 108 extend axially from the opposite ends of two of the four arcuate ridges 106. The two arcuate ridges 106 are to the left in FIG. 3. The axial ridges 108 extend downwardly from the arcuate ridges 106 to the annular rim 104 around the bottle neck 102. The circumferential spacing 114 between the pairs of axial ridges 108 is dimensioned to receive one of the lower lugs 92 of the lug assemblies. As seen in FIG. 4, the positioning of the bottle neck arcuate ridges 106 and axial ridges 108 is symmetric on opposite sides of a center plane 116 of the bottle neck.

In the preferred embodiment of the invention, the connector cap 12 is attached to the bottle neck 102 by being pressed axially downwardly on the bottle neck without rotating the connector cap relative to the bottle neck. In attaching the connector cap 12 on the bottle neck 102, the trigger sprayer is positioned relative to the bottle so that the connector cap center plane 82 is co-planar with the bottle neck center plane 116. This aligns the lower lugs 92 of the lug assemblies with the arcuate ridges 106 on the bottle neck 102. Continued axial downward movement of the connector cap 12 over the bottle neck 102 causes the cam surfaces 94 of the lower lugs 92 to engage with and slide over the arcuate ridges 106. This causes the arcuate ridges 106 to push radially outwardly on the lower lugs 92, and resiliently flexes the connector cap side wall 62 at the thin areas 78. This allows the lower lugs 92 to move radially outwardly relative to the arcuate ridges 106 as they are pushed axially downwardly over the ridges. When the lower lugs 92 pass over the arcuate ridges 106, they snap into position against the undersides of the arcuate ridges 106. In addition, two of the lower lugs 92 snap into the spacing 114 between the pairs of axial ridges 108. With the lower lugs 92 positioned beneath the arcuate ridges 106, the upper lugs 88 engage against the top of the arcuate ridges 106. This securely holds the connector cap 12 on the bottle neck 102 and prevents axial movement of the cap relative to the bottle neck. Furthermore, the engagement of two of the lower lugs 92 in the spacing 114 between the pairs of axial ridges 108 prevents the connector cap 12 from being rotated relative to the bottle neck 102. Still further, the engagement of the bottle neck annular rim 104 with the interior surface of cap side wall 62 securely holds the cap 10 on the container neck 102 and prevents any relative movement or rocking of the cap on the container neck. In this manner, the container cap 12 of the invention is attached to the bottle neck 102 by only being pressed axially downwardly onto the bottle neck, and without rotating the connector cap 12 relative to the bottle neck 102.

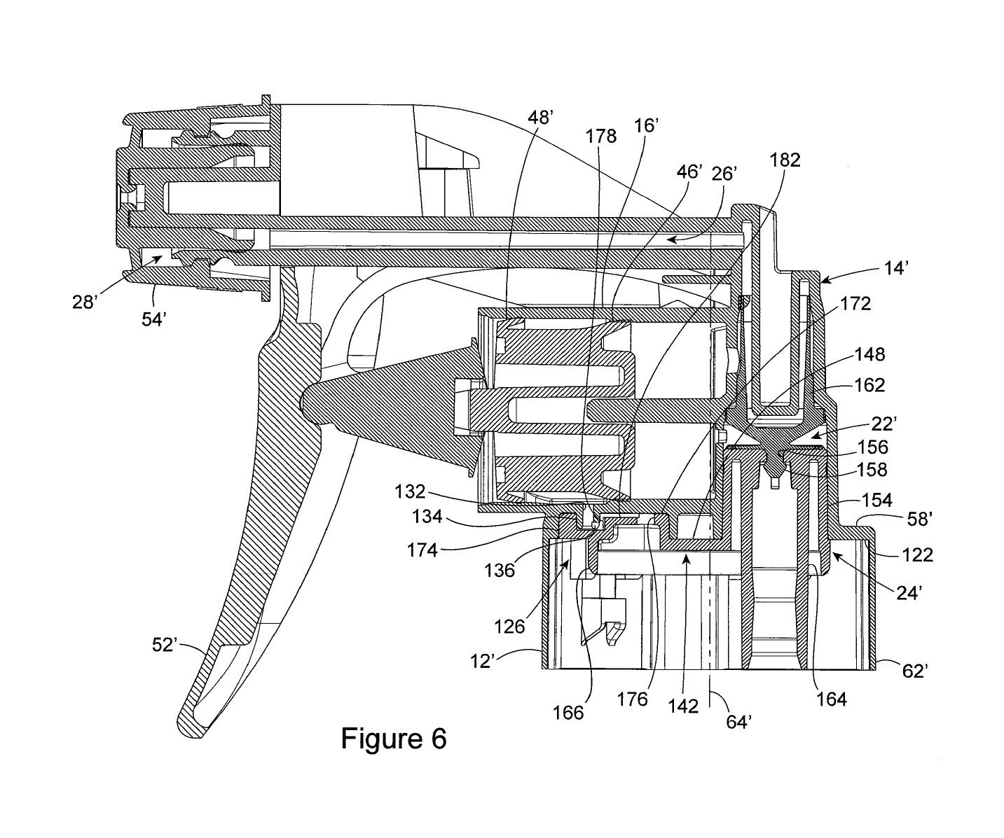

FIG. 6 shows a further example of a trigger sprayer construction similar to that of FIG. 1, but employing a slightly different construction of the plug seal 32 of FIG. 1. The component parts of the trigger sprayer shown in FIG. 6 that are basically the same as those shown in FIG. 1 are identified by the same reference numbers employed in FIG. 1, but the reference numbers are followed by a prime (′). The trigger sprayer of FIG. 6 operates in the same manner or the earlier described trigger sprayer of FIGS. 1-5.

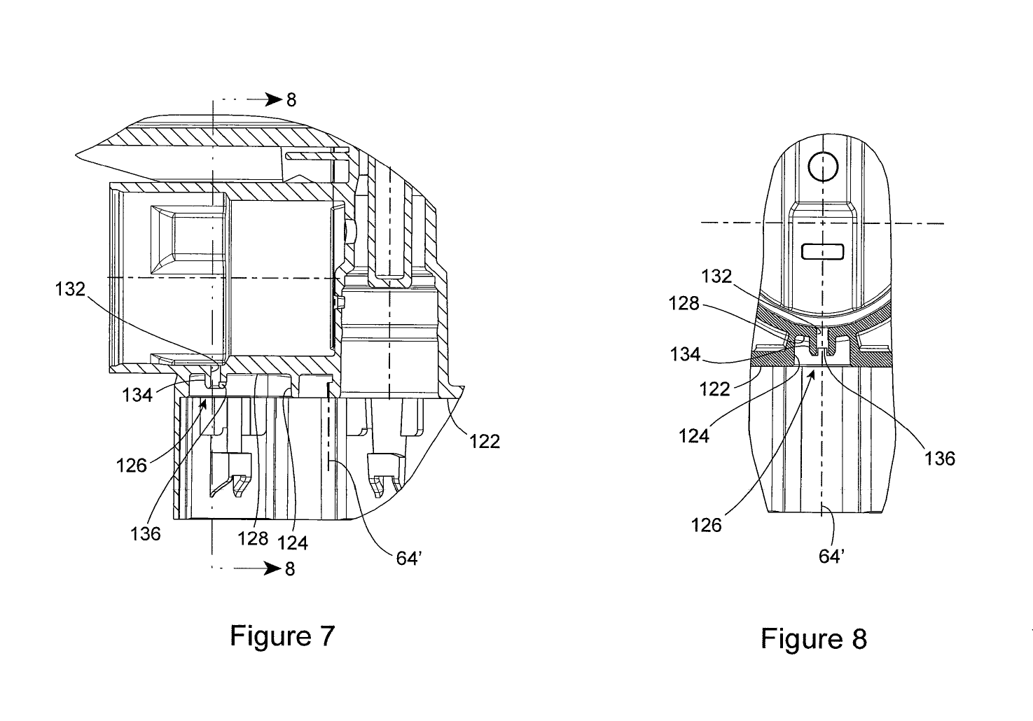

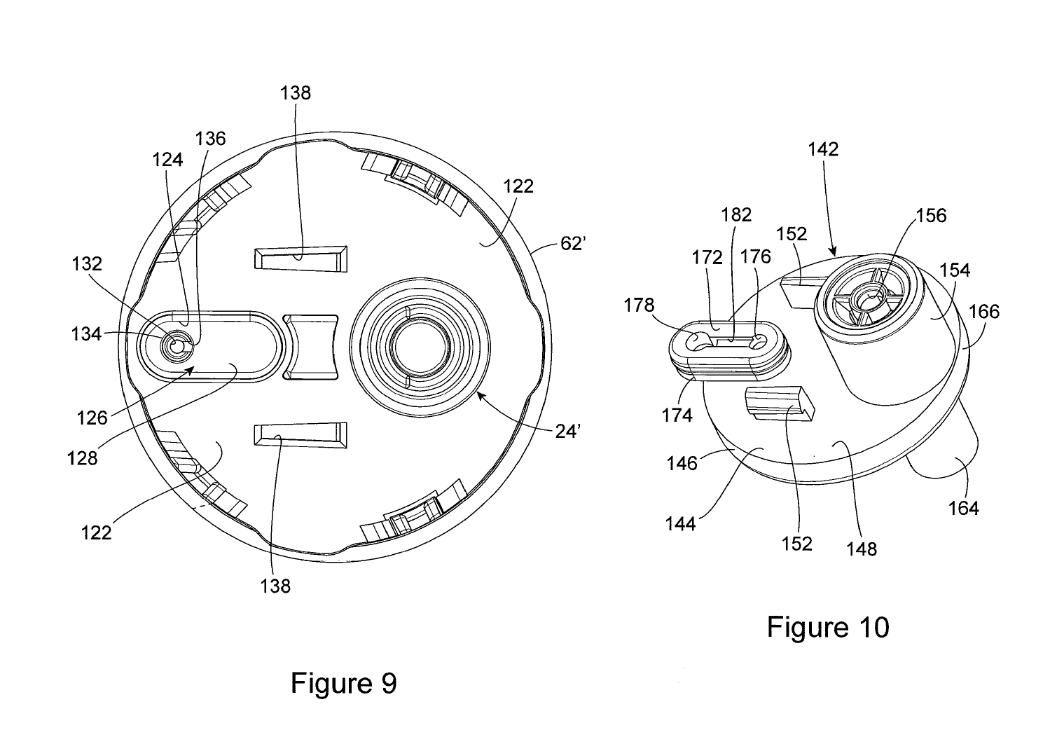

The trigger sprayer embodiment of FIG. 6-12 includes a trigger sprayer housing 14′ that has an integrally formed pump chamber 16′, a liquid supply passage 22′ communicating the pump chamber with a liquid inlet opening 24′, and a liquid discharge passage 26′ communicating the pump chamber with a liquid outlet opening 28′. A pump piston 46′ is mounted for reciprocating movement in the pump chamber 16′. A vent piston 48′ is integrally formed with the pump piston 46′ for reciprocating movement with the pump piston. A trigger 52′ mounted on the sprayer housing 14′ is operatively connected to the pump piston 46′ and the vent piston 48′ for reciprocating the two pistons in the pump chamber 16′ in response to manual oscillating movement of the trigger. An indexing valve 54′ is mounted on the liquid outlet opening 28′ and is manually rotatable to select a desired pattern of liquid discharge from the trigger sprayer. A connector cap 12′ is integrally formed with the sprayer housing 14′. The connector cap has a top wall 58′ that is also a bottom wall 122 of the sprayer housing 14′. The connector cap 12′ also has a cylindrical side wall 62′ that surrounds an interior volume of the connector cap 12′ and has a center axis 64′.

The following is a detailed description of the unique construction of the sprayer housing 14′ and plug seal 32′ shown in FIGS. 6-12 that enables a reduction in the number of component parts of the trigger sprayer of the invention, and provides a venting apparatus that allows air to flow into a liquid container attached to the trigger sprayer while substantially eliminating the leakage of liquid from the liquid container through the vent air flow path.

The sprayer housing bottom wall 122 has a circular shape. The bottom wall 122 is dimensioned to cover over an opening of a separate liquid container when the trigger sprayer is attached to the liquid container. The bottom wall 122 has a surface that is opposite the cap top wall 58′ and extends over the liquid container opening.

A cavity wall 124 is provided on the bottom wall surface 122. The cavity wall 124 surrounds a cavity 126 on the bottom wall surface 122. The cavity wall 124 extends into the bottom wall surface 122 to an end wall 128 of the cavity. In the embodiment of the sprayer housing shown in the drawing figures, the cavity wall 124 gives the cavity 126 an elongated or, more specifically, oblong configuration. Together the cavity wall 124 and the cavity end wall 128 define an interior volume of the cavity 126. As seen in the drawing figures, the cavity 126 is positioned at a diametrically opposite side of the connector cap center axis 64′ from the liquid inlet opening 24′.

The sprayer housing 14′ has a housing vent hole 132 that extends from the interior of the pump chamber 16′, through the sprayer housing bottom wall 122 and through the cavity end wall 128. The housing vent hole 132 is positioned at one end of the elongated configuration of the cavity 126. The exterior environment of the sprayer housing 14 is communicated with the interior volume of the cavity 126 through the housing vent hole 132.

A tube 134 extends from the cavity end wall 128 into the interior volume of the cavity 126. The tube 134 has a cylindrical tube wall that surrounds an interior bore of the tube and also surrounds the housing vent hole 132. As seen in the drawing figures, the tube 134 has a length that does not extend through the entire depth of the cavity 126 defined by the cavity wall 124. The cavity wall 126 has a larger length dimension than the tube 134. A slot 136 passages through the wall of the tube 134. As shown in the drawing figures, the positioning of the slot 136 in the wall of the tube 134 aligns the slot with the elongated length of the cavity 126. Thus, the interior volume of the cavity 126 is communicated through tube slot 136, through the interior bore of the tube 134, and through the housing vent hole 132 with the exterior environment of the sprayer housing 14′.

A pair of attachment openings 138 pass through the bottom wall surface 122 and through the top wall 58′ of the connector cap 12′. The attachment openings 138 are positioned on opposite sides of the cavity 126 and do not communicate with the cavity 126.

The plug seal 142 of the invention has a unique construction that combines several separate component parts of prior art trigger sprayers into a single component part. In addition, the plug seal 142 of the invention has a construction that, together with the novel construction of the sprayer housing bottom wall 122 creates a baffled air vent flow path that communicates an exterior environment of the trigger sprayer with the interior volume of a liquid container connected to the trigger sprayer, but prohibits liquid from leaking from the liquid container through the air vent flow path. The plug seal 142 is shown assembled to the sprayer housing 14 in FIG. 6, and is shown disassembled from the sprayer housing in FIGS. 10-12.

The plug seal 142 has a disk configuration 144 with a circular peripheral edge 146 that are best seen in FIG. 10. The disk peripheral edge 146 is dimensioned to fit in a tight, sealing fit inside the sprayer housing connector cap 12′ as shown in FIG. 6. The plug seal 142 has a plug surface 148 that is assembled against the sprayer housing bottom wall surface 122 when the plug seal 142 is assembled to the sprayer housing 14′. The plug seal surface 148 seals the bottom wall surface 122 to the opening of the liquid container when the sprayer housing 14′ is attached to the liquid container.

In the preferred embodiment, the entire plug seal 142 is constructed of a flexible material, for example a plastic material, that is softer than the material employed in constructing the sprayer housing 14′. This enables the plug seal disk 144 and the plug seal surface 148 to function as a sealing gasket in the connection between the sprayer housing 14′ and the liquid container.

A pair of resilient flanges or tabs 152 are provided on the plug seal surface 148. The tabs 152 project outwardly from the plug seal surface 148 and extend through the pair of attachment openings 138 provided in the sprayer housing bottom wall 122. In this manner, the tabs 152 securely attach the plug seal 142 to the sprayer housing 14′ with the plug seal surface 148 engaging against the bottom wall surface 122 of the sprayer housing 14′.

A valve seat column 154 is formed integrally with the plug seal disk 144 and extends into the liquid inlet opening 24′ of the sprayer housing 14′. The valve seat column 154 is similar to that of the first described embodiment, except that it includes an attachment hole 156 at the center of the valve seat surface of the column 154. The attachment hole 156 receives an enlarged head 158 of a center post of a double valve element 162 that, apart from the center post and post head 158, has the same construction as the double valve element of the previously described embodiment. The engagement of the post head 158 in the valve seat column attachment hole 156 securely attaches the double valve element 162 to the plug seal 142. This facilitates the assembly of the double valve element 162 and the plug seal 142 into the sprayer housing 14′.

A tubular dip tube connector 164 is integrally formed with the plug seal disk 144 on an opposite side of the disk from the valve seat column 154. In the first described embodiment the dip tube connector 164 is axially misaligned with the valve seat column 154 as shown in FIG. 1. This enables the positioning of the dip tube connector 164 and the attached dip tube (not shown) at the center of the connector cap 12′ when attaching the cap to a liquid container. In the embodiment shown in FIG. 6, the dip tube connector 164 is axially aligned with the valve seat column 154.

An annular rim 166 extends from the plug seal disk 144 around the dip tube connector 164. The rim 166 is dimensioned to fit in sealing engagement inside the opening of the liquid container when the trigger sprayer is attached to the liquid container.

Thus, the plug seal 142 of the invention forms as one integral piece the sealing disk 144, the tabs 152 that secure the disk to the sprayer housing 14′, the valve seat column 154, the dip tube connector 164, and the annular sealing rim 166. In addition, the double valve element 162 being secured to the valve seat column 154 by the post head 158 facilitates the assembly of the double valve and the plug seal into the sprayer housing, and reduces manufacturing cost.

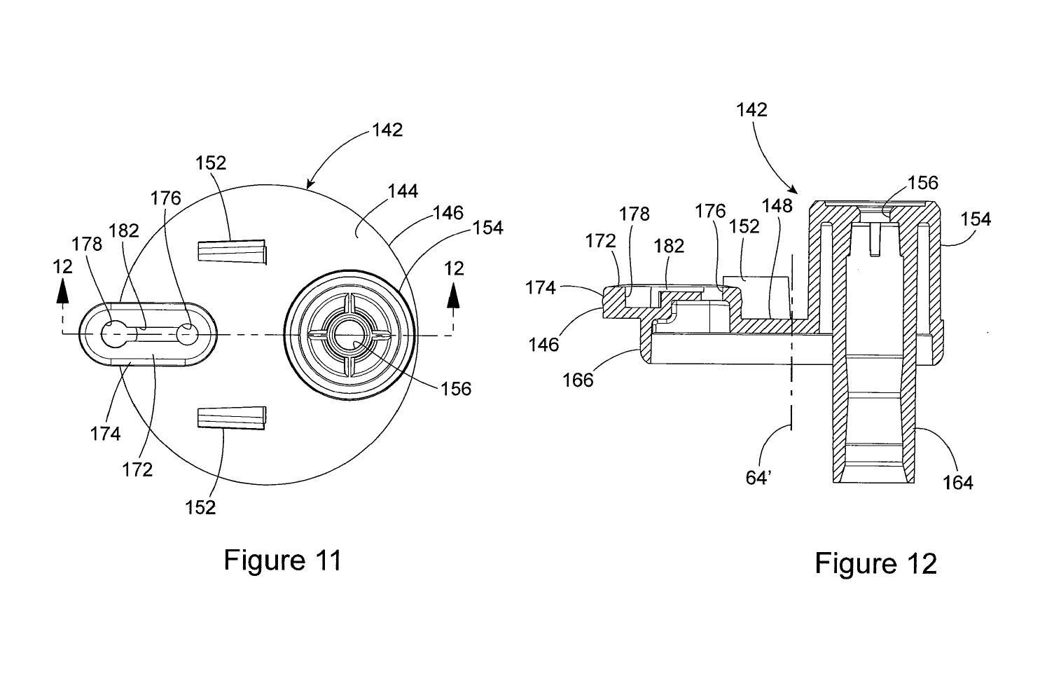

In addition to the above, the unique construction of the plug seal 142 creates a baffled air flow path when the plug seal is assembled to the sprayer housing 14′. An elongate trough 172 is formed on the plug seal surface 148. The trough 172 in the illustrated embodiment has an oblong configuration defined by a sidewall 174 of the trough. The trough sidewall 174 is dimensioned to extend into the sprayer housing bottom wall cavity 126 and to engage in a sealing fit against the cavity wall 124. The height of the trough sidewall 174 is substantially the same as the height of the cavity wall 124 so that the trough also engages against the cavity end wall 128. As seen in FIGS. 10 and 11, the elongate length of the trough 172 extends a portion of the trough beyond the peripheral edge 146 of the plug seal disk 144.

A plug hole 176 passes through the plug seal 142 and through the trough 172. The plug hole 176 is positioned at one end of the elongate length of the trough 172 that is closest to the valve seat column 154 of the plug seal 142. The plug hole 176 communicates with the opening of the liquid container when the trigger sprayer is attached to the liquid container.

A cylindrical tube receptacle 178 is formed in the trough 172. The receptacle 178 is positioned at an end of the elongate length of the trough 172 that is opposite the end having the plug hole 176. As seen in FIG. 6, the tube reciprocal 178 has a depth that substantially corresponds to the length of the sprayer housing tube 134. In addition, a majority of the interior surface of the tube receptacle 174 engages against the exterior surface of the sprayer housing tube 134, except for a portion of the tube receptacle 178 that is positioned closes to the plug hole 176.

A vent channel 182 is formed in the trough 172 and extends between the plug hole 176 and the tube receptacle 178. The vent channel 182 communicates the plug hole 176 with the tube receptacle 178, and through the tube slot 136, communicates the plug hole 176 with the interior bore of the tube 134 and the sprayer housing vent hole 132.

The plug seal 142 assembled to the sprayer housing 14′ creates an air venting flow path that communicates the interior of a liquid container attached to the trigger sprayer with an exterior environment of the trigger sprayer while prohibiting leakage of liquid from the liquid container through the trigger sprayer. When the pump piston 46′ and vent piston 48′ are moved to the discharge positions in the pump chamber 16′, the exterior environment of the sprayer housing 14′ communicates with the opening of the attached liquid container through the sprayer housing vent hole 132, the interior bore of the sprayer housing tube 134, the tube slot 136, the tube receptacle 178 in the trough 172 of the plug seal 142, the vent channel 182 in the trough 172, and the plug hole 176 through the trough and the plug seal. Thus, the unique construction of the plug seal 142 employed on the trigger sprayer of the invention combines several separate component parts employed in prior art trigger sprayers into one integral piece, and provides a unique air vent baffle system that allows air to vent through the trigger sprayer to a liquid container attached to the trigger sprayer while substantially preventing leakage of liquid from the liquid container through the trigger sprayer.

Although the present invention has been described above by reference to specific embodiments, it should be understood that modifications and variations of the invention may be constructed without departing from the scope of the invention defined in the following claims.

1) A trigger sprayer venting apparatus comprising:
a sprayer housing having a bottom wall with a bottom wall surface that extends over an opening of a separate liquid container when the sprayer housing is attached to the liquid container;
a cavity wall surrounding a cavity on the bottom wall surface, the cavity wall extending into the cavity to a cavity end wall where the cavity wall and the cavity end wall define an interior volume of the cavity on the bottom wall surface;
a sprayer housing vent hole passing through the bottom wall and the cavity end wall, the sprayer housing vent hole communicating an exterior environment of the sprayer housing with the interior volume of the cavity;
a tube extending from the cavity end wall into the cavity interior volume, the tube having a tube wall that surrounds an interior bore of the tube and surrounds the sprayer housing vent hole, the tube having a slot through the tube wall that communicates the cavity interior volume through the tube slot, the tube interior bore and the sprayer housing vent hole with the exterior environment of the sprayer housing; and,
a plug seal having a plug surface that is assembled against the bottom wall surface and seals the bottom wall to the opening of the liquid container when the sprayer housing is attached to the liquid container;
a plug hole passing through the plug seal, the plug hole communicating with the opening of the liquid container when the sprayer housing is attached to the liquid container;
a tube receptacle in the plug seal, the tube receptacle receiving the tube extending from the cavity end wall; and,
a vent channel in the plug seal and extending between the plug hole and the tube receptacle, whereby the exterior environment of the sprayer housing communicates with an opening of a separate liquid container through the sprayer housing vent hole, the tube interior bore, the tube slot, the tube receptacle on the plug seal surface, the channel in the plug seal, and the plug hole through the plug seal when the sprayer housing is attached to the liquid container.

2) The apparatus of claim 1, further comprising:
the plug seal having a circular disk configuration that is dimensioned to seal closed an opening of a liquid container when the sprayer housing is attached to the liquid container.

3) The apparatus of claim 2, further comprising:
the plug seal having an annular rim that extends into an opening of a liquid container when the sprayer housing is attached to the liquid container.

4) The apparatus of claim 1, further comprising:
the plug seal having a tubular dip tube connector that extends from an opposite side of the plug seal from the plug seal surface.

5) The apparatus of claim 4, further comprising:
the plug seal having a valve seat column that extends from the plug seal surface opposite the dip tube connector.

6) The apparatus of claim 5, further comprising:
the valve seat column having a valve seat surface on an opposite end of the valve column from the plug seal surface; and, a disk valve attached to the valve seat column over the valve seat surface.

7) The apparatus of claim 1, further comprising:
a connector cap on the sprayer housing, the connector cap having a cylindrical sidewall with a center axis and axially opposite first and second ends, the cylindrical sidewall attaches the sprayer housing to a separate liquid container; and, the sprayer housing bottom wall extends over the connector cap sidewall first end.

8) A trigger sprayer venting apparatus comprising:
a sprayer housing having a bottom wall with a bottom wall surface that extends over an opening of a separate liquid container when the sprayer housing is attached to the liquid container;
a cavity wall surrounding a cavity on the bottom wall surface, the cavity wall extending into the cavity to a cavity end wall where the cavity wall and the cavity end wall define an interior volume of the cavity on the bottom wall surface;
a sprayer housing vent hole passing through the bottom wall and the cavity end wall, the sprayer housing vent hole communicating an exterior environment of the sprayer housing with the interior volume of the cavity;
a plug seal having a plug surface that is assembled against the bottom wall surface and seals the bottom wall to the opening of the liquid container when the sprayer housing is attached to the liquid container;
a trough on the plug surface, the trough extending from the plug surface into the cavity surrounded by the cavity wall on the bottom wall surface;
a plug hole passing through the plug seal and the trough, the plug hole communicating with the opening of the liquid container when the sprayer housing is attached to the liquid container; and,
a vent channel in the trough and extending between the plug hole and the sprayer housing vent hole, whereby the exterior environment of the sprayer housing communicates with an opening of a separate liquid container through the sprayer housing vent hole, the vent channel in the trough, and the plug hole through the plug seal and the trough when the sprayer housing is attached to the liquid container.

9) The apparatus of claim 8, further comprising:
the plug seal having a circular disk configuration that is dimensioned to seal closed an opening of a liquid container when the sprayer housing is attached to the liquid container.

10) The apparatus of claim 9, further comprising:
the plug seal having an annular rim that extends into an opening of a liquid container when the sprayer housing is attached to the liquid container.

11) The apparatus of claim 8, further comprising:
the plug seal having a tubular dip tube connector that extends from an opposite side of the plug seal from the plug seal surface.

12) The apparatus of claim 11, further comprising:
the plug seal having a tubular valve seat column that extends from the plug seal surface opposite the dip tube connector.

13) The apparatus of claim 12, further comprising:
the valve seat column having a valve seat surface on an opposite end of the valve column from the plug seal surface; and, a disk valve attached to the valve column over the valve seat surface.

14) The apparatus of claim 8, further comprising:
the plug seal having a circular disk configuration with a peripheral edge; and,
the trough having an elongate configuration that extends beyond the peripheral edge of the plug seal.

15) the apparatus of claim 8, further comprising:
the cavity on the bottom wall surface having an elongate configuration with the sprayer housing vent hole and the plug seal hole being at opposite ends of the cavity elongate configuration.

16) The apparatus of claim 8, further comprising:
the trough on the plug seal having an elongate configuration with the plug seal hole and the sprayer housing vent hole being at opposite ends of the trough elongate configuration.

17) The apparatus of claim 8, further comprising:
the trough engaging against the cavity end wall.

18) The apparatus of claim 8, further comprising
the cavity sidewall engaging around the trough.

19) A trigger sprayer venting apparatus comprising:
a sprayer housing having a bottom wall with a bottom wall surface that extends over an opening of a separate liquid container when the sprayer housing is attached to the liquid container;
a cavity wall surrounding a cavity on the bottom wall surface, the cavity wall extending into the cavity to a cavity end wall where the cavity wall and the cavity end wall define an interior volume of the cavity on the bottom wall surface;
a sprayer housing vent hole passing through the bottom wall and the cavity end wall, the sprayer housing vent hole communicating an exterior environment of the sprayer housing with the interior volume of the cavity;
a tube extending from the cavity end wall into the cavity interior volume, the tube having a tube wall that surrounds an interior bore of the tube and surrounds the sprayer housing vent hole, the tube having a slot through the tube wall that communicates the cavity interior volume through the tube slot, the tube interior bore and the sprayer housing vent hole with the exterior environment of the sprayer housing; and,
a plug seal having a plug surface that is assembled against the bottom wall surface and seals the bottom wall to the opening of the liquid container when the sprayer housing is attached to the liquid container;
a trough on the plug surface, the trough extending from the plug surface into the cavity surrounded by the cavity wall on the bottom wall surface;
a plug hole passing through the plug seal and the trough, the plug hole communicating with the opening of the liquid container when the sprayer housing is attached to the liquid container;
a tube receptacle in the trough, the tube receptacle receiving the tube extending from the cavity end wall; and,
a vent channel in the trough and extending between the plug hole and the tube receptacle, whereby the exterior environment of the sprayer housing communicates with an opening of a separate liquid container through the sprayer housing vent hole, the tube interior bore, the tube slot, the tube receptacle in the trough on the plug seal surface, the channel in the trough, and the plug hole through the plug seal and the trough when the sprayer housing is attached to the liquid container.

20) The apparatus of claim 19, further comprising:
the plug seal having a circular disk configuration that is dimensioned to seal closed an opening of a liquid container when the sprayer housing is attached to the liquid container.

21) The apparatus of claim 20, further comprising:
the plug seal having an annular rim that extends into an opening of a liquid container when the sprayer housing is attached to the liquid container.

22) The apparatus of claim 19, further comprising:
the plug seal having a tubular dip tube connector that extends from an opposite side of the plug seal from the plug seal surface.

23) The apparatus of claim 22, further comprising:
the plug seal having a tubular valve column that extends from the plug seal surface opposite and aligned with the dip tube connector.

24) The apparatus of claim 23, further comprising
the valve column having a valve seat surface on an opposite end of the valve column from the plug seal surface; and,
a disk valve attached to the valve column over the valve seat surface.

25) The apparatus of claim 19, further comprising:
the plug seal having a circular disk configuration with a peripheral edge; and,
the trough has an elongate configuration that extends beyond the peripheral edge of the plug seal.

26) The apparatus of claim 19, further comprising:
the cavity on the bottom wall surface having an elongate configuration with the sprayer housing vent hole and the plug seal hole being at opposite ends of the cavity elongate configuration.

27) The apparatus of claim 19, further comprising:
the trough on the plug seal having an elongate configuration with the plug seal hole and the sprayer housing vent hole being at opposite ends of the trough elongate configuration.

28) The apparatus of claim 19, further comprising:
the trough engaging against the cavity end wall.

29) The apparatus of claim 19, further comprising:
the cavity sidewall engaging around the trough.
